(19) United States
(12) Patent Application Publication
(10) Pub. No.: US 2023/0053701 A1
(43) Pub. Date: Feb. 23, 2023

(54) SYSTEMS AND METHODS FOR PROVIDING REAL-TIME TRACKING SERVICES

(71) Applicant: THE SAFE DOT LLC, Hermitage, TN (US)

(72) Inventors: Barbara Collier, Nashville, TN (US); DeLisa Guerrier, Nashville, TN (US)

(21) Appl. No.: 17/889,487

(22) Filed: Aug. 17, 2022

Related U.S. Application Data
(60) Provisional application No. 63/235,534, filed on Aug. 20, 2021.

(51) Int. Cl. G06Q 50/26; G07C 9/00

(52) U.S. Cl. CPC G06Q 50/265; G07C 9/00563

(57) ABSTRACT

Systems and methods herein provide real-time tracking services regarding individuals (e.g., school children) being transported from origin to destination. Host servers may selectively assign each individual to respective ones of the transports based on input from caregiver-specific user interfaces, and generate an expected group of individuals for transport to each respective driver via transport driver-specific interfaces. Each individual is identified upon boarding a respective transport vehicle, at least in part by capturing identification data from a QR dot associated with the individual via a verification device associated with the transport vehicle. If at least one individual is unexpectedly aboard/ not aboard a specified one of the transport vehicles, an intervention alert is generated to the associated caregiver(s) and/or transport driver interfaces substantially in real time. In an embodiment, all relevant parties accordingly can confirm whether a child has boarded the correct bus, gotten off the bus, and at what location.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS REFERENCES TO RELATED APPLICATIONS

This application claims the benefit of U.S. Provisional Pat. Application No. 63/235,534, filed Aug. 20, 2021, and which is hereby incorporated by reference in its entirety.

### BACKGROUND

The present invention relates generally to systems and methods with provide real-time tracking services. More particularly, an embodiment of an invention as disclosed herein relates to a host system that coordinates with computing devices for caregivers and transport providers to provide at least real-time tracking and possible intervention regarding transport of individuals such as children, for example to/ from school via buses.

Numerous problems exist in the art in relation to child safety. This includes ensuring safety in being transported to and from schools and other locations. For example, a child taking a bus to school might get on a wrong bus either intentionally or unintentionally, leaving parents and guardians concerned and entities such a schools and caregivers potentially liable for any harm caused as a result.

What is needed is a way to provide real-time tracking of individuals or groups, such as a single child or group of children to and/or from a school or caretaker facility.

### BRIEF SUMMARY

Embodiments of the present disclosure provide apparatuses, systems, and methods for providing real-time tracking services. Provided herein are apparatuses, systems, and methods which resolve issues regarding shortcomings in existing systems.

Implementations consistent with the present disclosure may provide a platform configured to provide safety and accountability for the transfer of students to and from school on buses. Implementations consistent with the present disclosure may provide parents, school administrators, bus drivers, and bus attendants real-time access to a child’s scheduled bus route. Everyone may thus know if the child has gotten onto the bus, has gotten off the bus, and where the child got off the bus. This may limit liability to school administrations and give peace of mind to parents.

In an embodiment as disclosed herein, a system which may be hosted from a network of servers, a cloud computing platform, or the like as further described below provides real-time tracking services regarding individuals (e.g., children) being transported from an origin (e.g., a school) to a destination (e.g., as specified by an authorized caretaker). A server may be selectively linked via a communications network to respective first computing devices associated with one or more authorized caretakers for each of the individuals, to respective second computing devices associated with one or more authorized users for each of a plurality of transport vehicles, and to at least one respective verification device associated with each of the plurality of transport vehicles. Each of the verification devices may be configured to capture identification data from a machine-recognizable and/or machine-identifiable element associated with a respective individual while boarding the associated transport vehicle. The server may be configured to receive input data from the first computing devices assigning each of the individuals to a respective one of the plurality of transport vehicles, generate an expected group of individuals for each of the plurality of transport vehicles, ascertain that at least one individual is unexpectedly aboard or not aboard a specified one of the plurality of transport vehicles, based on the generated expected group of individuals for the specified transport vehicle and on the captured identification data via the at least one verification device associated with the specified transport vehicle, and upon ascertaining that the at least one individual is unexpectedly aboard or not aboard the specified one of the plurality of transport vehicles, to generate at least a first intervention alert to at least one of the first computing devices and/or second computing devices substantially in real time.

In an exemplary aspect according to the above-referenced embodiment, the machine-recognizable and/or machine-identifiable element associated with each respective individual may comprise a respective QR dot. Each QR dot may for example have one or more sets of information stored in association therewith. The information may in some embodiments be stored within or otherwise extracted directly from the QR dot, or otherwise the one or more sets of information stored in association with each QR dot may reside in data storage functionally linked to the server, wherein at least one of the one or more sets of information is dynamic and adjustable via input from the respective one or more authorized caretakers.

In another exemplary aspect according to the above-referenced embodiment, the machine-recognizable and/or machine-identifiable element associated with each respective individual may comprise a captured image. In such a case, each verification device may for example be configured to reference the captured image against a database of facial recognition data to identify the respective individual. Alternatively, or in addition, the server may be configured to reference the captured image against a database of facial recognition data to identify the respective individual.

In another exemplary aspect according to the above-referenced embodiment, the server may be further configured to generate a user interface comprising visual indicia on each second computing device indicating whether each of the expected group of individuals has boarded the respective transport vehicle.

In another exemplary aspect according to the above-referenced embodiment, the server may be further configured to receive, pursuant to the at least first intervention alert, authorization from at least one of the one or more first computing devices associated with an individual ascertained as being unexpectedly aboard or not aboard the specified one of the plurality of transport vehicles, and to determine whether at least one further individual is still unexpectedly aboard or not aboard the specified one of the plurality of transport vehicles.

In another exemplary aspect according to the above-referenced embodiment, the first intervention alert is dynamic with respect to one or more hierarchical status parameters defining at least a first status in which an unexpected boarding state exists but requires no input from an associated caregiver for resolution, and a second status in which an unexpected boarding state exists and requires further input from an associated caregiver. The one or more hierarchical status parameters may for example comprise at least a period of time in which an unexpected boarding state must be resolved before transitioning from the first status to the second status.

In another exemplary aspect according to the above-referenced embodiment, each of the individuals may be assigned to a respective one of the plurality of transport vehicles, for each day of a week and further for each of transport from the origin to the destination and transport from the destination to the origin, based on input data received via the first computing devices.

In another exemplary aspect according to the above-referenced embodiment, the server may be further configured to selectively generate route data specific to one or more of the expected group of individuals on a display unit associated with the second computing device, and further to update the route data in substantially real time based on corresponding inputs from a respective caregiver.

Numerous objects, features and advantages of the embodiments set forth herein will be readily apparent to those skilled in the art upon reading of the following disclosure when taken in conjunction with the accompanying drawings.

### BRIEF DESCRIPTION OF THE SEVERAL VIEWS OF THE DRAWINGS

FIG. 1 illustrates an exemplary embodiment of a partial block network diagram according to aspects of the present disclosure.

FIG. 2 illustrates an exemplary embodiment of a partial block diagram of a status interface according to aspects of the present disclosure.

FIG. 3 illustrates an exemplary embodiment of a flowchart for a method according to aspects of the present disclosure.

### DETAILED DESCRIPTION

While the making and using of various embodiments of the present disclosure are discussed in detail below, it should be appreciated that the present disclosure provides many applicable inventive concepts that can be embodied in a wide variety of specific contexts. The specific embodiments discussed herein are merely illustrative of specific ways to make and use the implementations consistent with the present disclosure and do not delimit the scope of the present disclosure.

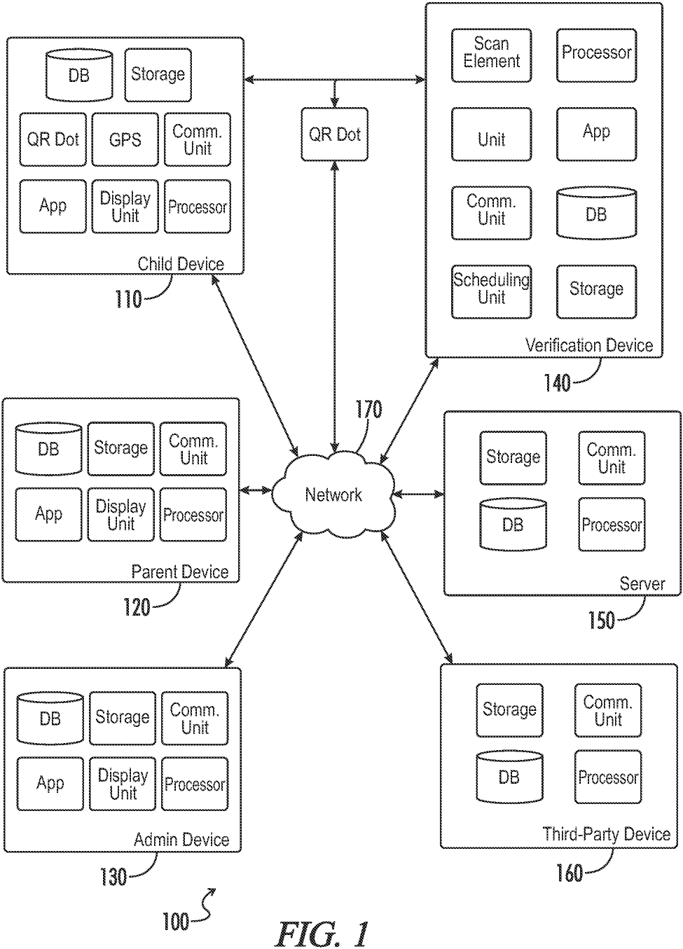

Referring generally to FIGS. 1- 3 various exemplary apparatuses, systems, and associated methods according to the present disclosure are described in detail. Where the various figures may describe embodiments sharing various common elements and features with other embodiments, similar elements and features are given the same reference numerals and redundant description thereof may be omitted below.

FIG. 1 illustrates an exemplary embodiment of a partial block network diagram according to aspects of the present disclosure. The system 100 is a simplified partial network block diagram reflecting a functional computing configuration implementable according to aspects of the present disclosure.

The system 100 includes one or more of a child device 110, a parent device 120, an admin device 130, a verification device 140, a server 150, and/or a third-party device 160 coupleable to a network 170. In one exemplary embodiment, the network 170 may include the Internet, a public network, a private network, and/or any other communications medium capable of conveying electronic communications. Connection between elements or components of the system 100 may be configured to be performed by wired interface, wireless interface, or combination thereof, without departing from the spirit and the scope of the present disclosure. At least one of the child device 110, parent device 120, admin device 130, verification device 140, server 150, and/or third-party device 160 may include a communication unit configured to permit communications, for example via the network 170.

In one exemplary operation, at least one of the child device 110, parent device 120, admin device 130, verification device 140, server 150, and/or third-party device 160 includes a volatile and/or non-volatile storage and/or database configured to store one or more sets of instructions and/or data. The one or more sets of instructions may be configured to be executed by a processor of the child device 110, parent device 120, admin device 130, verification device 140, server 150, and/or third-party device 160 to perform operations corresponding to the one or more sets of instructions.

In various exemplary embodiments, at least one of the child device 110, parent device 120, admin device 130, verification device 140, server 150, and/or third-party device 160 is implemented as at least one of a desktop computer, a server computer, a laptop computer, a smart phone, or any other electronic device capable of executing instructions. One or more of the child device 110, parent device 120, admin device 130, verification device 140, server 150, and/or third-party device 160 may include a processor, such as a generic hardware processor, a special-purpose hardware processor, or a combination thereof. In embodiments having a generic hardware processor (e.g., as a central processing unit (CPU) available from manufacturers such as Intel and AMD), the generic hardware processor is configured to be converted to a special-purpose processor by means of being programmed to execute and/or by executing a particular algorithm in the manner discussed herein for providing a specific operation or result. It should be appreciated that the processor may be any type of hardware and/or software processor or component and is not strictly limited to a microprocessor or to any operation(s) only capable of execution by a microprocessor.

One or more computing component and/or functional element illustrated by FIG. 1 may be configured to operate remotely from an associated child device 110, parent device 120, admin device 130, verification device 140, server 150, and/or third-party device 160, and may be further configured to obtain or otherwise operate upon one or more instructions stored physically remote from one or more child device 110, parent device 120, admin device 130, verification device 140, server 150, and/or third-party device 160, and/or functional element (e.g., via client-server communications or cloud-based computing via the network 170).

At least one of the child device 110, parent device 120, admin device 130, verification device 140, server 150, and/or third-party device 160 may include a display unit. The display unit may be embodied within the computing component or functional element in one embodiment and may be configured to be either wired to or wirelessly interfaced with at least one other computing component or functional element. The display unit may be configured to operate, at least in part, based upon one or more operations of the described herein, as executed by an associated processor.

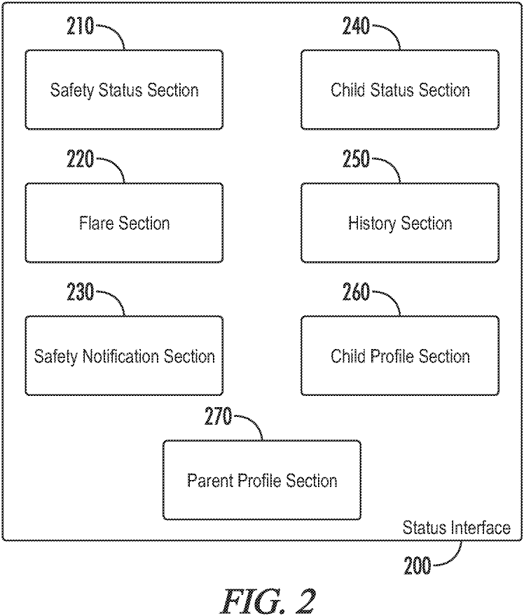

FIG. 2 illustrates an exemplary embodiment of a partial block diagram of a status interface according to aspects of the present disclosure. A status interface 200 may be displayable, in whole or in part, by a display unit of one or more of a child device 110, a parent device 120, an admin device 130, and/or a verification device 140. The status interface 200 may include one or more of a safety status section 210, a flare section 220, a safety notification section 230, a child status section 240, a history section 250, a child profile section 260, and/or a parent profile section 270. Although illustrated by FIG. 2 as being simultaneously present on the status interface, one or more of the safety status section 210, flare section 220, safety notification section 230, child status section 240, history section 250, child profile section 260, and/or parent profile section 270 may be separately displayable in terms of timing and/or visual portion of the status interface 200 without departing from the spirit and scope of the present disclosure. One or more portion of the status interface 200 or setting thereof may be configured to be tailored according to a user of the status interface 200. For example, a parent device 120 might have one or more different abilities or information access/control compared to an admin device 130 and/or verification device 140.

The status interface 200 may be presented by an app running on one or more of a child device 110, a parent device 120, an admin device 130, and/or a verification device 140. Additionally, or alternatively, at least a portion of the status interface 200 or information provided thereby may be obtained from a remote source, for example via the network 170, for example using a webpage or portal.

In an exemplary embodiment for an administration dashboard, the status interface 200 may include a base dashboard screen (e.g., as a webpage accessible via the network 170) optionally containing one or more of a background, a Safe Dot logo, a “Kids Safe” bubble (which may for example be colored green or otherwise selectively presented for user delineation), an “Incidents” bubble, a “Flares” bubble, a settings icon, an “Add Parent/Child” button, and/or a “Reports” button. The status interface 200 may include an input screen enabling an administration user to enter parent information, for example using the parent profile section 270. Parent information may include a first name, last name, e-mail address, work telephone number, cellular telephone number, or other information relating to or associated with one or more parent. The status interface 200 may include an input screen enabling an administration user to enter child information, for example using the child profile section 260. Child information may include a first name, last name, a nickname, and e-mail address (if applicable), a cellular telephone number (if applicable), one or more addresses, one or more alternative drop off locations optionally in association with schedule information, or other information relating to or associated with one or more child.

In the administration dashboard example, a status interface 200 reflecting an all-good scenario may include the background, the Safe Dot logo, the Kids Safe bubble identifying all students (e.g., 129 students) within a safe status, the Incidents bubble reflecting zero known incidents, the Flares bubble reflecting zero known flares, the settings icon, the Add Parent/Child button, and the Reports button. In contrast, in the administration dashboard example where an incident is known, the status interface 200 may include the background, the Safe Dot logo, the Kids Safe bubble identifying less than all students (e.g., 128 of 129 students) within a safe status, the Incidents bubble may reflect a total number of known incidents optionally along with incident information, the Flares bubble reflecting zero known flares, the settings icon, the Add Parent/Child button, and the Reports button. The incident information displayable by the status interface 200 may include a child identifier such as a first and/or last name, an incident type such as entered a wrong bus, a timestamp, a countdown timer such as an animated gif, and/or an action item, such as an identification that the student was sent to a bus attendant as a result of the detected incident. The system may be configured to transition the status interface 200 to an all-good status upon expiration of the countdown timer corresponding to a detected incident.

In an exemplary embodiment for a parent device 120, the status interface 200 may include a parent registration screen (e.g., provided via an app installed at a parent device 120) optionally containing one or more of a parent information input ability (e.g., via the parent profile section 270) and/or a child information input ability (e.g., via the child profile section 260). A parent may be permitted to provide child schedule information, for example including a child’s name, a location name, one or more days of the week, a date picker, and/or address information.

In an exemplary embodiment for a parent dashboard, the status interface 200 may include a base dashboard screen (e.g., provided via an app installed at a parent device 120) optionally containing one or more of a background, a current status bubble (e.g., green in a child safe condition), a child absence (e.g., for sickness, vacation, or other reason) indication bubble, a history section, and/or a settings icon.

One or more safety update notifications may be provided to a parent via the status interface 200, for example using the safety notification section 230. Visual conveyance of at least a portion of a safety update notification may be provided via an overlay of the parent dashboard screen. An instance overview may be provided to a parent, including one or more of a type of instance (e.g., that a child check into a wrong bus), an action response status (e.g., that the child was moved to the proper bus based upon the detected instance), and an instance status (e.g., active or issue resolved). In various embodiments, once an issue is resolved, a parent dashboard may be updated to reflect an all-good status, for example via the current status bubble.

An authorized user such as a bus driver may use a verification device 140 to perform at least one operation in association with a child’s QR dot. As used herein, a QR dot may be implemented, in whole or in part, via a machine and/or human-recognizable and/or identifiable element configured to convey information in relation to a user, student, bus, parent, guardian, or any other useable information. Although described as a QR dot, it should be appreciated that one or more sets of information associated with a QR dot or forming at least a portion of a QR dot may be any form of visual conveyance of information, such as a QR code, plaintext, an image or graphic, a scannable item, or any other means of conveying information. In various exemplary embodiments, a QR dot may be a card or other element providing a scannable or readable portion, such as a QR code or electronically identifiable object.

A dot may include, for example, one or more of a silicone sleeve, a leather patch, a wearable element, and/or any format or element for providing or being associated with a scannable or readable portion of a QR dot. A silicone sleeve may be used to form or to house at least a portion of a QR dot. For example, a silicon sleeve may be configured to receive at least a portion of a QR dot therein and may optionally include a transparent or open space in which a visible portion of the QR dot may be seen, for example including an associated QR code portion thereof. A leather patch may similarly be configured to form or to house at least a portion of a QR dot. The leather sleeve may be embossed with a viewable or scannable element in various embodiments. Additionally, or alternatively, the leather patch may be configured to receive at least a portion of a QR dot therein and may optionally include a transparent or open space in which a visible portion of the QR dot may be seen, for example including an associated QR code portion thereof. A wearable element may include, for example, a bracelet, a lanyard, and/or any other wearable item which is configured to form and/or receive at least a portion of a QR dot. At least a portion of the wearable element may form part of the wearable element and/or may be configured to receive at least a portion of a QR dot therein and may optionally include a transparent or open space in which a visible portion of the QR dot may be seen, for example including an associated QR code portion thereof. In various exemplary embodiments, optical and/or biometric information such as facial recognition, fingerprints, and/or other technologies may be implemented as or in conjunction with the use of QR dots as described herein. For example, in various exemplary embodiments, a child may be scanned onto or off of a bus using an image capture of a verification device 140, a database of facial recognition data may be referenced to determine an identity of a child, and the system may operate as described herein. Additionally or alternatively, facial recognition and/or biometric data may be used to actively track and/or to provide verification of user or group data (such as to confirm bus count and/or identities).

In various exemplary embodiments, a scan element of the verification device may be used to scan a child’s QR dot upon entering and/or exiting a physical location or bus, or at any time to determine a presence status of the child (e.g., as either present or not present). Although described with reference to scanning a QR dot, it should be appreciated that visual indicia other than QR codes, indicia other than visual indicia, or any form of active or passive detection or measurement used to determine a presence status may be used without departing from the spirit and scope of the present disclosure.

During operation, the verification device 140 may be configured to provide an Active Mode QR Scan Screen, for example via an app executed by the verification device 140. The Active Mode QR Scan Screen may include one or more of a Settings icon, a visual presence section which may include a listing of scanned QR dot status and an optional visual status such as a screenshot or camera view (e.g., a visual representation within a bus), and/or a View Route button. When a child’s QR dot is successfully scanned, a scan success screen may be displayed by the verification device 140, and may include a Settings icon, a QR scan status indication, for example a listing of scanned QR dot status and an optional visual status such as a screenshot or camera view (e.g., a visual representation within a bus), and/or a View Route button. In various embodiments, the QR scan status indication may include an overlay section displaying information such as a child’s name whose QR dot has been successfully scanned, along with an indication of whether the child is properly in a location where scanned (e.g., the child is on the proper bus). The verification device 140 may permit a user such as a bus driver to view child-specific route information, for example by selecting a View Route button via the app executed by the verification device 140. An unsuccessful QR dot scan may be visually indicated by the verification device 140, for example to notify a user such as a bus driver that the child is not boarding a proper assigned bus and to enable the user to take further action, such as to direct the child to a proper bus or to obtain the assistance of a bus attendant who may direct the child to the proper bus. The system may be configured to verify whether a duplicate QR scan is detected in various embodiments.

The verification device 140 may track a list of children scheduled to be on a bus in various embodiments, and may visually convey the list, for example by identifying proper presence status (e.g., with a green checkmark or other indicia) or improper presence status such as absent or on a wrong bus (e.g., using a red X or other indicia). A user of the verification device 140 may be provided with the ability to view and/or confirm each child’s pick-up location and/or time, drop-off location and/or time, or any other information relating to a child, route, or aspect of the system capable of enabling one or more operations described herein.

One or more bus attendant may use a verification device 140 in a manner described herein to monitor, track, and/or perform at least one operation in relation to a child. At least a portion of app executed by the verification device 140 may include a plurality of bus attendant screens or portions of information thereof. The bus attendant screens or portions thereof may include information and/or interactivity for one or more of an active mode QR scan screen having one or more of a settings icon and/or a QR scanner portion. Additional active mode QR scan, child scan, and/or child details screens may be presented in conjunction with a verification device 140 in various exemplary embodiments.

As used in conjunction with the present disclosure, there may be a plurality of system user types. Five illustrative and non-limiting examples of user types may include the following.

A Child User Type may include a child that is picked up and/or dropped off for at a location such as a school at a designated time/date (e.g., every school day). This user type’s interaction with the system may be implemented by scanning an associated element such as a QR Dot once they get arrive at or exit a location or entity such as a school bus or school location.

A Parent User type may include parents, guardians, or authorized individuals or groups associated with a child. This user type may be permitted to create and/or modify one or more associated schedule(s), such as one or more children’s schedules. This user type may receive one or more notifications when an associated individual or group such as a child or associated plurality of children is picked up and/or dropped off successfully and may be sent one or more “flares” when the child is picked up or dropped off in the wrong location.

A Bus Driver User type may include bus driver or associated individual or group that picks up and/or drops off one or more individuals or groups such as a child or children at their associated address(es) and/or school(s). This user type’s responsibility may include the ability to confirm that each child scans their associated element such as a QR Dot when arriving at and/or departing a location or known entity (e.g., getting on and/or off a bus). This user type may be configured as not being able to check an individual or group in or out of a known location or element, such as a bus.

A Bus Attendant User Type may include a person or person who is enabled to help an individual or group (e.g., children) find or to direct the individual or group to a correct location and/or entity, such as a right bus. This user type may be optionally prevented from checking an individual or group (e.g., child or children) in or out of a location and/or entity (such as a bus).

An Administrator User type (e.g., Admin) may be configured to permit at least a portion of the overall administration of the system. This user may be enabled to enter in one or more of Parents, Children, Bus Drivers, Bus Attendants, and/or other Admins. This user type may be permitted to see real-time data of one or more open “Flares,” and may be enabled and/or required to enter in notes for one or more (or all) instances when they occur.

As used herein, the term Instances may refer to when an individual or group (e.g., a child or children) has checked in or out on the wrong location or entity (such as a bus or route). Instances may optionally be enabled and/or required to have one or more notes attributed to them for transparency to all involved, which will be time stamped, and cannot be edited once submitted.

Instance Notifications may include one or more notifications transmittable to Administrators when an individual or group (e.g., child or children) has checked in or out in conjunction with a wrong location or entity (such as a bus or route), and may take the form of an electronic communication such as an e-mail and/or text message. The system may be configured such that if an Instance Notification isn’t resolved in under a set time period (e.g., ten minutes), a Flare may be transmitted to an associated Parent or Guardian in the form of an e-mail, a text message, a push notification, and/or other form of electronic messaging or communication.

Flares may include one or more notifications configured to be transmitted to one or more Parents and Guardians when an individual or group (e.g., child and/or children) has checked in or out on the wrong location or entity (such as a bus or a route), but has not been corrected or updated via an Administrator. This may be sent via text message, e-mail, app push notifications, or other form of electronic messaging.

Safety Notifications may be configured such that once an Instance has been rectified and/or overridden by an Administrator, Safety Notifications will go out to an associated Parent and/or Guardian letting them know that there was an Instance, but that is has been resolved.

According to implementations consistent with the present disclosure, a basic system flow by user type in the morning may be provided. The flow may begin with a child getting onto a bus in the morning. The child may scan their associated element such as a QR Dot at a verification device 140 (such as a tablet mountable on a dashboard or other element of a school bus or other vehicle). The system may be configured to confirm that the child is on the right bus. If the child is on the right bus/route, the system may send a message to one or more associated parents and/or guardians via the method(s) of their choosing - e.g., via one or more app push notification, text message, e-mail, and/or may notify the bus driver on the verification device 140 using visual indicia such as a large green checkmark. If, however, the child is on the wrong bus/route, and the situation hasn’t been resolved in under ten minutes by an Administrator, the system may be configured to send a “flare” notification to one or more Parents and/or Guardians for example via an app push notification, a text message, an e-mail, and/or notification to the bus driver on the verification device 140 with a visual indicia such as a large red X.

As the child leaves the bus, they may be permitted to scan the verification device 140 (e.g., as a tablet mounted on the dashboard). If the child scans their QR Dot at the school location to signify they're at the school, Parents and/or Guardians may be notified via one or more of the method(s) of their choosing - e.g., via app push notification, text message, e-mail, and/or other electronic messaging or communication. If the child does not scan their card (e.g., including a QR Dot or other identifiable element) to signify they are at school by a certain time, and if the situation hasn’t been resolved in under ten minutes by an Administrator, the system may be configured to send a “flare” notification to one or more Parents and/or Guardians, for example via app push notification, text message, e-mail, and/or electronic message or communication.

As for implementations involving a child user flow in the afternoon, a child may first get on a bus after school. The child may scan their associated element such as a QR Dot at a verification device 140 (such as a tablet mounted on the dashboard or other element of a vehicle or space. The system may selectively confirm that the child is on the right bus. If the child is on the right bus/route, the system may be configured to send a message to one or more parents and/or guardians via one or more of the method(s) of their choosing - e.g., via app push notification, text message, e-mail, or other electronic message or communication, and may be configured to notify the bus driver on the verification device 140 (e.g., tablet) with a visual indicia such as a large green checkmark. If the child is on the wrong bus/route, the Bus Driver may be permitted to send the child to a Bus Attendant where they may point the child to the correct Bus and/or call an Administrator to resolve the issue.

If the situation hasn’t been resolved in under a set time period (such as ten minutes) by an Administrator, the system may be configured to send a “flare” notification to one or more Parents and/or Guardians, for example via app push notification, text message, e-mail, and/or other electronic message or communication and may notify the bus driver, for example on the verification device 140 with a visual indicial such as a large red X. As the child leaves the bus, they may be permitted to scan the verification device 140 (e.g., as implemented as a tablet mounted on the dashboard or other portion of vehicle, location, and/or space). If a child scans their QR Dot at an appropriate drop off spot, one or more Parents and/or Guardians may be notified via the method(s) of their choosing - e.g., via app push notification, text message, e-mail, and/or other electronic messaging or communication. If the child scans their QR Dot at an inappropriate drop off spot, and if the situation hasn’t been resolved in under ten minutes by an Administrator, the system may be configured to send a “flare” notification to one or more Parents and/or Guardians via app push notification, a text message, an e-mail, and/or other electronic message or communication, and may notify a bus driver via the verification device 140, for example using a large red X.

In various exemplary embodiments, a Parent User setup flow may include a Parent receiving an email from The Safe Dot system asking them to register via a link to an electronic marketplace, such as the Apple App Store or Google Play Store. A Parent may be permitted to install the app and may permitted to create an account password. The Parent may be permitted to view a “feature walkthrough,” which may include one or more of providing instructions regarding how to set up the home address, how to set up additional addresses and schedules, and/or the importance of telling the system that a child is sick or won’t be attending school on one or more particular days. Once in the app, the parent may view that their children are already pre-entered into the system by The Safe Dot in various embodiments. The parent may be prompted to do one or more of the following:
1. Enter in the “Home Address” to verify where the child may or must be dropped off
2. Enter in any “Additional Addresses” the child may be dropped off at, but on specific days only
3. Choose the days of the week that the child is supposed to be picked up and dropped off at the applicable addresses
4. Set up their notification preferences (e.g., Push Notification; Text Message; Email).

A Dashboard may be provided to the Parent and may include one or more of the following: Overview (e.g., Child Safe, Flare(s)), and/or Safety Notification(s)); Child is Sick Button (to prompt the parent to put in that the child is sick or will not be going to school that day, which will deactivate the system for them that day); History; Child Profile; Parent Profile.

One or more flares may be generated for associated situations including, e.g., Wrong pickup bus in morning; Wrong drop-off bus in morning; Wrong pickup bus in afternoon; Wrong drop-off bus in afternoon; No pickup at all in morning; No drop-off at all in morning; No pickup at all in afternoon; No drop-off at all in afternoon.

One or more safety notifications may be generated for associated situations including, e.g., Resolved wrong pickup bus in morning, Resolved wrong drop-off bus in morning, Resolved wrong pickup bus in afternoon, Resolved wrong drop-off bus in afternoon, Resolved no pickup at all in morning, Resolved no drop-off at all in morning, Resolved no pickup at all in afternoon, Resolved no drop-off at all in afternoon

In various exemplary embodiments, a Parent Usage flow may enable a Parent to use the app to see the current status of the child, update address and schedules, change their notification messages for Child On/Off Bus successfully notifications, view pickup and drop-off history, provide Sick or Vacation input (e.g., disabling the system for that day).

Parents may also (selectively or automatically) receive notifications following one or more of: Child boards bus successfully; Child exits bus successfully; Flares for issues that haven’t been resolved by Administrators; Safety Notifications once an Instance is safely remedied Bus

In various exemplary embodiments, a Bus Driver User morning flow may include one or more of the following: Bus driver enters the bus and turns on the tablet, clicking The Safe Dot app to engage; Bus Driver logs in; The app auto updates the children’s schedule for the day with internet access; The driver clicks the “Let’s Go” button which confirms with the system that the driver is on their way for their first pickup; The driver sees a list of children’s names and addresses to be picked up at their homes/etc. for the day; The driver picks up the first child, requesting that the child scans their QR Dot; The system confirms that the child is supposed to be picked up by this bus; The driver requests that each child scans their QR Dot while leaving the bus; Once all children have exited the bus, the bus driver will click the “Done For The Day” button, which will let the system know that the route is complete.

In various exemplary embodiments, a Bus Driver afternoon flow may include one or more of the following: Bus driver enters the bus and turns on the tablet, clicking the Safe Dot app to engage; Bus Driver logs in; The app auto updates the children’s schedule for the day with internet access; The driver clicks the “Let’s Go” button which confirms with the system that the driver is on their way to the school; The driver sees a list of children’s names and addresses to be picked up at the school for the afternoon drop-off; The driver requests that all children scan their QR Dot while entering the bus at the bus pickup at school; The system confirms that the child is supposed to be picked up by this bus; If a child is on the wrong bus, the Bus Driver will request that the Child visit a Bus Attendant; The driver requests that each child scans their QR Dot while leaving the bus; Once all children have exited the bus, the bus driver will click the “Done For The Day” button, which will let the system know that the route is complete.

In various exemplary embodiments, a Bus Attendant afternoon user flow may include one or more of the following: Bus Attendant logs in for the day on their phone; Bus Attendant sees a QR Dot scanner; Once the Bus Attendant scans a child’s QR Dot, they can see the child’s list of pickup and drop-off schedules as well as the applicable bus number; The Bus Attendant may optionally be prevented from manually overriding one or more settings, addresses, or sick days in various embodiments. Additionally, or alternatively, the bus attendant may be permitted to override one or more settings, addresses, or sick days in various embodiments without departing from the spirit and scope of the present disclosure.

In various exemplary embodiments, an Administration user flow/ administration input flow may include one or more of the following: Parent/Child Input (wherein the Administrator inputs parents and their children into the system, and assigns a QR Dot to each child); Bus Input Flow; Bus Driver Input Flow; Bus Attendant Input Flow.

In various exemplary embodiments, an Administration daily usage flow may include one or more of the following: Admins may create, read, update, and delete the schedules and addressees of each child manually as needed; a dashboard will be visible for Admins to see all safe students active Instances, and Flares that parents receive; notes on Instances & Flares such as, e.g., Admins receive notifications for each Instance, and may or must make the applicable update (e.g., within ten minutes); if the Instance isn’t resolved in a predetermined or dynamically determined time period (such as ten minutes), a Flare may be transmitted to the Parent/Guardian; Admins may or must make notes for each Instance based on reports from the child, bus driver, bus attendant, and parent.

The following provides an exemplary process flow order according to aspects of the present disclosure. An Admin may input Parent and Student information and submits to the system. The Admin may view an Admin Dashboard to see “Children Safe” is 129 “Instances” at 0 and “Flares” at 0. A Parent may view an app registration screen, may walk through schedule and address input, and may save corresponding child data. A Parent may view a Parent Dashboard with all “Flares” which is 0 And a “Child Safe” button. A Bus Driver may watch a child scan a QR Dot into the Bus Driver app. Child 1 QR Dot scan 1 may be added successfully, showing the child’s name with indicia such as a green checkmark. A Parent’s app may show a corresponding “Child Safe” screen. An Admin’s app shows a “Children Safe” section as 129 “Instances” at 0 and “Flares” at 0. Child 2's QR Dot scan 2 may be unsuccessful, showing the child’s name with a “Wrong Bus” notification. An Instance notification may be sent to the Admin dashboard with the Child’s Name, Current Bus Number, Correct Bus Number, Parent’s Phone Number, and email. The Admin’s app may then show “Children Safe” is 128 “Instances” at 1 and “Flares” at 0. The Bus Attendant may scan the child’s QR Dot, and the Bus Attendant’s screen may show the correct bus number. Child 2's QR Dot scan 1 may be added successfully to the new bus number, showing the child’s name with a green checkmark. A Parent’s app may show a “Safety Notification” with details of what happened and what was corrected. A “Children Safe” value may then be 129, an “Instances” value may be 0, and a “Flares” value may be 0.

Features implementable in accordance with the present disclosure may include one or more of a single page scroller business presence website, an administration content management system, usage management, incident management, bus management, child schedule management, call child in sick, and/or settings. The single page scroller business presence website may include one or more of a Quick Highlights Slider, at least one How it Works box, an About The Safe Dot section, a Frequently Asked Questions (FAQs) section, and/or a Contact Us section.

An Administration Content Management System may include one or more features relating to: Login (e.g., Email, Password, Lost password functionality); Base Dashboard (e.g., Current Safe Children Bubble w/ qty, Current Incidents Bubble w/ qty, Current Flares Bubble w/ qty, List of "Sick" children that are not applicable to the system that day, List of "Addresses To Update" (based on parent’s entering in new addresses to their child’s schedule)); User Management- Admins (e.g., First Name, Last Name, Email, Telephone (e.g., cell) Number); User Management- Parent(s) (e.g., First Name, Last Name, Email, Work Number, Cell Number); User Management- Student(s) as may also or otherwise be assigned as a child to a parent (e.g., First Name, Last Name, Nickname, Email (if applicable), Cell Phone Number (if applicable), Sick Status); User Management- Bus Drivers (e.g., First Name, Last Name, Email, Cell Number); User Management- Bus Attendants (e.g., First Name, Last Name, Email, Cell Number); Usage Management (e.g., Development Notes as sortable by date, child, bus, bus driver, and bus attendant, Checked into Bus date/time & Bus #, and Bus Driver Name, Checked off Bus date/time & Bus #, and Bus Driver Name, Scanned by Bus Attendant, date/time, and Bus e Attendant Name, Child Sick Day, Addresses updated by Parent/Administrator); Incident Management (e.g., Date, Timestamp, Child Involved, Timestamped Actions such as "Checked into" Bus date/time & Bus #, and Bus Driver Name, "Checked off'' Bus date/time & Bus #, and Bus Driver Name, Scanned by Bus Attendant, date/time, and Bus Attendant Name); Bus Management (e.g., Bus number, Bus Notes such as Time Stamped, "Checked into" Bus date/time & Bus #, and Child’s Name, "Checked off'' Bus date/time & Bus #, and Child’s Name); Child Schedule Management (e.g., Day of Week, Pickup Address Bus, Dropoff Address); Call Child In Sick.

A Parent App may include one or more features relating to: Login; Dashboard (e.g., “Current Status” Bubble re Child Safe, Flare, and/or Safety Notification; Child Is Sick Button; History; Settings Icon); Parent Flare Notification Screen with an overlay of Dashboard Screen (e.g., only sent if not resolved in ten minutes by an Admin and optionally including Situation (wrong bus number, not picked up, etc.), “Incident Not Resolved”); Parent Safety Notification Screen including an overlay of Dashboard Screen (e.g., “Incident Resolved”, Situation (Child Safely on Bus #, etc.)); Children(s) Schedule (e.g., pickup and drop off information for each day of week); Call Child In Sick Button (e.g., to keep the child from Incidents or Flares for the selected dates).

A Bus Driver App may include one or more features relating to: Login; Scanning Capability (e.g., QR Dot Scanner with Positive Indication re Child’s First Name and Child’s Last Name, or Negative Indication re Child’s First Name, Child’s Last Name, or View Schedule Button; pickup and drop off address for each day of the week).

A Bus Attendant App may include one or more features relating to: Login; Scanning Capability (e.g., QR Dot Scanner); Review Child’s Schedule (e.g., pickup and drop off information for each day of the week).

In various exemplary embodiments, the Parent App may be implemented to provide ease of use to a user. Admins may only have access to the web-based dashboard, and no app logins in various embodiments. The Bus Driver app may be configured to work on a tablet such as an iPad, and may optionally be configured to operate in portrait mode on the tablet. The Bus Attendant app may be configured to work on both iOS and Android Mobile devices, and may optionally be configured not to operate on Tablet devices such as an iPad or Android tablet device. In various exemplary embodiments, no app or website may be configured to support dark mode. Both the Parent app and Bus Attendant app may be configured to support portrait mode only. The Bus Driver app may be configured to work with offline access in the case that they are without cell service, including restart memory saving, and the system may be configured to update as soon as the app receives internet service of any kind. QR Dot Codes may be configured to as not to be manually entered, for example by enabling and/or requiring a Dot Card.

In various exemplary embodiments, if a child has not scanned the “on bus” or “off bus” by a certain time, the system may be configured to send out a flare, potentially once the Bus Driver clicks the “Done for the day” button. Each time a child checks in and out of a bus, the GPS coordinates may also be sent with the notification to the system. Periodic update requests to Parents may be provided to make sure their addresses are up to date for child drop-offs. Real-time GPS tracking of buses and each child that is on the bus may be provided. One-off daily address change overrides (e.g., ability to for a child to be dropped off at a location in one day without overriding the overall schedule) may be provided. A real-time tracking element may be provided for the parents and/or guardians to show where their child is at in real-time based on their status (e.g., picked up, on their way, dropped off, etc.). Children’s addresses can be imported (e.g., via an excel sheet) by Admins in the CMS. Bus driver pictures may be permitted and/or required in various embodiments. Buses outside of a geolocation zone may be configured to send notifications to Admins and Parents. When buses are running late, the system may be configured to notify the Parents and Admins.

LMS Integration such as Skyway or the like may be implemented according to aspects of the present disclosure. Bus Attendants may be on a schedule which schedules, tracks, and/or requires them to be at the bus pickup, and notifies the Admins if the Bus Attendant doesn’t arrive on time, leaves early, logs out before they're supposed to, etc. Automated phone call notifications (e.g., using robotic or live voices) may be provided as an option for Notifications. Best bus route pickup and drop-off times based on real-time Google map integration. GPS-enabled Dot Badges may be provided for real-time access to a child’s location. Check-ins and Check-outs for Bus Drivers may be enabled to log their hours. A SaaS platform may be implemented in addition to or alternative to standalone instances. Detailed statistics may be provided to show the safety rating of each bus driver and student.

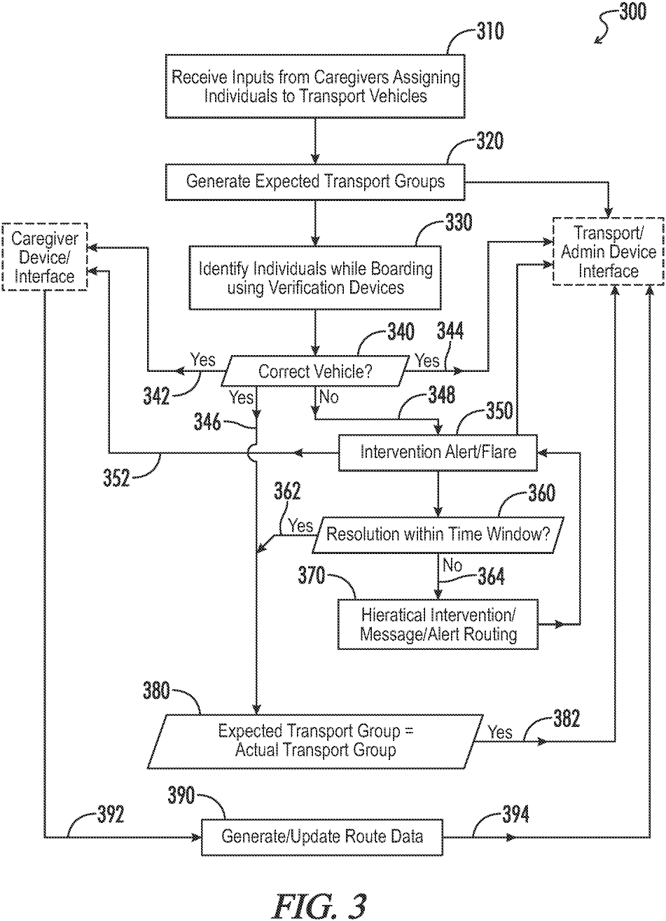

With further reference to FIG. 3, an exemplary embodiment of a method 300 for providing real-time tracking services regarding individuals being transported from an origin to a destination may be described, and which generally speaking may implement one or more aspects of the devices and systems as disclosed above with respect to FIGS. 1 and 2.

In one step 310 of the method 300, which may relate generally to numerous actions taken by users of a system as disclosed herein over time and accordingly is not intended as being temporally ahead of or otherwise static with respect to each other step in the method, a host server may selectively open, generate, or otherwise utilize a user interface for each of various respective user computing devices associated with children, authorized caretakers, bus drivers, bus attendants, administrators, and the like, wherein the system receives input data from at least one respective caregiver to assign each of the individuals (e.g., children) to a particular transport vehicle (e.g., bus). As otherwise noted herein, the input data in this context may be used to selectively assign individuals to a given transport vehicle (or different transport vehicles where appropriate) for each day of a week and further for each of transport from the origin to the destination and transport from the destination to the origin. The “destination” in this context and for an initial (i.e., morning) daily transport may be a school and the “origin” in this context may be the home of the individual, but these terms may understandably be reversed for subsequent transport in the afternoon, and any number of alternative transport nodes may be identified. For example, an individual may be assigned for pickup at a first caregiver site, but dropped off at a different caregiver site.

Having received the input data from the caregivers, the system may further generate an expected group of individuals for each of the plurality of transport vehicles (step 320). This expected group of individuals for a given transport vehicle may be used to populate a portion of a user interface associated with the respective driver, for example along with indicia to indicate to the driver which individuals have previously boarded. In some embodiments, the driver may be presented with indicators that an individual that normally would be included on the transport vehicle is not being transported on that day, or that an individual that is not normally included on that transport vehicle is to be transported on that day.

In step 330, each of the verification devices capture identification data from a machine-recognizable and/or machine-identifiable element (e.g., QR dot) associated with a respective individual while boarding (or in a different context, exiting) the associated transport vehicle. Various embodiments of such elements and verification devices may be implemented as previously described herein. In the context of different QR dots being associated with the various individuals, each QR dot may have one or more sets of information stored in association therewith. The information in some embodiments may be stored within the QR dot and extracted therefrom. The information in other embodiments may reside in data storage functionally linked to the server, some or all of which may be dynamic in nature such that it is adjustable via input from the respective one or more authorized caretakers.

In step 340, the system (directly at the verification device and/or remotely at the host server) determines whether an individual has entered the correct vehicle (or is exiting at the correct destination). If the individual has been properly identified and confirmed as being aboard the correct vehicle, the system may further generate confirmation or equivalent indicia via the caretaker(s) user interface (step 342), and/or may generate confirmation or equivalent indicia via the driver user interface (step 344), and/or may further determine whether this individual has completed the expected group of individuals for that transport vehicle (step 346).

If the system alternatively ascertains that an individual is unexpectedly aboard or not aboard a specified transport vehicle (step 348), based on the generated expected group of individuals for the specified transport vehicle and on the captured identification data via the at least one verification device associated with the specified transport vehicle, at least a first intervention alert (e.g., flare) may be generated (step 350) to a caregiver device (step 352) and/or transport driver device and/or administrator device (step 354) substantially in real time. Such intervention alerts may be dynamic in nature, based in some examples on the underlying basis or context for the alert, and based in other or additional examples on input from associated caregivers. Such contexts may include hierarchical status parameters defining for example a first status in which an unexpected boarding state exists but requires no input from an associated caregiver for resolution, a second status in which an unexpected boarding state exists and requires further input from an associated caregiver, and the like.

In various embodiments, a period of time may be predetermined for all such intervention alerts or may be customized based on user input for a given individual, wherein the system determines in step 360 whether or not the intervention alert has been resolved by an administrator or other user. If so, the system may proceed in step 362 to for example determine whether the transport vehicle is fully and properly loaded (see step 380). If the intervention alert or underlying cause thereof has not been resolved in that time period, however, the system may proceed in step 370 to a second level of intervention alert, and/or route the previous intervention alert to a determined alternative recipient, and/or generate a message to caregivers if the initial intervention was directed solely for example to transport vehicle drivers, etc., as illustrated in FIG. 3 as a return to step 350 and a new/ revised intervention alert (or flare).

In various embodiments, after the transport vehicle has been confirmed as boarded with each of the expected individuals for delivery to their respective destinations, the system may further in step 390 selectively generate route data specific to one or more of the expected group of individuals on a display unit. The route data may be rendered on an onboard display unit for the transport vehicle, such as for example integrated with the verification device, and/or may be rendered on a display unit for the computing device associated with the driver. The route data may in various embodiments be updated in substantially real time based on corresponding inputs from a respective caregiver, such as for example where the desired destination needs to be changed after the individual has already boarded the vehicle.

To facilitate the understanding of the embodiments described herein, a number of terms are defined below. The terms defined herein have meanings as commonly understood by a person of ordinary skill in the areas relevant to the present disclosure. Terms such as “a,” “an,” and “the” are not intended to refer to only a singular entity, but rather include the general class of which a specific example may be used for illustration. The terminology herein is used to describe specific embodiments consistent with the present disclosure, but their usage does not delimit the present disclosure, except as set forth in the claims. The phrase “in one embodiment,” as used herein does not necessarily refer to the same embodiment, although it may.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/ storage medium. In the alternative, the medium can be integral to the processor. The processor and the medium can reside in an ASIC. The ASIC can reside in a user terminal. In the alternative, the processor and the medium can reside as discrete components in a user terminal.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A system for providing real-time tracking services regarding individuals being transported from an origin to a destination, the system comprising:
a server selectively linked via a communications network to respective first computing devices associated with one or more authorized caretakers for each of the individuals, to respective second computing devices associated with one or more authorized users for each of a plurality of transport vehicles, and to at least one respective verification device associated with each of the plurality of transport vehicles;
wherein each of the verification devices are configured to capture identification data from a machine-recognizable and/or machine-identifiable element associated with a respective individual while boarding the associated transport vehicle;
wherein the server is configured to
receive input data from the first computing devices assigning each of the individuals to a respective one of the plurality of transport vehicles,
generate an expected group of individuals for each of the plurality of transport vehicles,
ascertain that at least one individual is unexpectedly aboard or not aboard a specified one of the plurality of transport vehicles, based on the generated expected group of individuals for the specified transport vehicle and on the captured identification data via the at least one verification device associated with the specified transport vehicle, and
upon ascertaining that the at least one individual is unexpectedly aboard or not aboard the specified one of the plurality of transport vehicles, to generate at least a first intervention alert to at least one of the first computing devices and/or second computing devices substantially in real time.

2. The system of claim 1, wherein the machine-recognizable and/or machine-identifiable element associated with each respective individual comprises a respective QR dot.

3. The system of claim 2, wherein each QR dot has one or more sets of information stored in association therewith.

4. The system of claim 3, wherein the one or more sets of information stored in association with each QR dot resides in data storage functionally linked to the server, and wherein at least one of the one or more sets of information is dynamic and adjustable via input from the respective one or more authorized caretakers.

5. The system of claim 1, wherein the machine-recognizable and/or machine-identifiable element associated with each respective individual comprises a captured image.

6. The system of claim 5, wherein each verification device is configured to reference the captured image against a database of facial recognition data to identify the respective individual.

7. The system of claim 5, wherein the server is configured to reference the captured image against a database of facial recognition data to identify the respective individual.

8. The system of claim 1, wherein the server is further configured to generate a user interface comprising visual indicia on each second computing device indicating whether each of the expected group of individuals has boarded the respective transport vehicle.

9. The system of claim 1, wherein the server is further configured to:
receive, pursuant to the at least first intervention alert, authorization from at least one of the one or more first computing devices associated with an individual ascertained as being unexpectedly aboard or not aboard the specified one of the plurality of transport vehicles; and
determine whether at least one further individual is still unexpectedly aboard or not aboard the specified one of the plurality of transport vehicles.

10. The system of claim 1, wherein the first intervention alert is dynamic with respect to one or more hierarchical status parameters defining at least a first status in which an unexpected boarding state exists but requires no input from an associated caregiver for resolution, and a second status in which an unexpected boarding state exists and requires further input from an associated caregiver.

11. The system of claim 10, wherein the one or more hierarchical status parameters comprise at least a period of time in which an unexpected boarding state must be resolved before transitioning from the first status to the second status.

12. The system of claim 1, wherein each of the individuals are assigned to a respective one of the plurality of transport vehicles, for each day of a week and further for each of transport from the origin to the destination and transport from the destination to the origin, based on input data received via the first computing devices.

13. The system of claim 1, wherein the server is further configured to selectively generate route data specific to one or more of the expected group of individuals on a display unit associated with the second computing device, and further to update the route data in substantially real time based on corresponding inputs from a respective caregiver.

14. A computer-implemented method of providing real-time tracking services regarding individuals being transported from an origin to a destination, the method comprising:
selectively generating respective first user interfaces on computing devices associated with one or more authorized caretakers for each of the individuals, and respective second user interfaces on computing devices associated with each of a plurality of transport vehicles leaving the same origin or arriving at the same destination;
assigning each of the individuals to a respective one of the plurality of transport vehicles based on input data received via the first user interfaces;
generating an expected group of individuals for each of the plurality of transport vehicles;
identifying each of the individuals upon boarding a respective transport vehicle, at least in part by capturing identification data from a machine-recognizable and/or machine-identifiable element associated with a respective individual via a verification device associated with the transport vehicle; and
upon ascertaining that at least one individual is unexpectedly aboard or not aboard a specified one of the plurality of transport vehicles, generating at least a first intervention alert to at least one of the first user interfaces and/or second user interfaces substantially in real time.

15. The method of claim 14, comprising generation of visual indicia on each second user interface indicating whether each of the expected group of individuals has boarded the respective transport vehicle.

16. The method of claim 14, further comprising:
receiving, pursuant to the at least first intervention alert, authorization from at least one of the one or more first user interfaces associated with an individual ascertained as being unexpectedly aboard or not aboard the specified one of the plurality of transport vehicles; and
determining whether at least one further individual is still unexpectedly aboard or not aboard the specified one of the plurality of transport vehicles.

17. The method of claim 14, wherein the first intervention alert is dynamic with respect to one or more hierarchical status parameters defining at least a first status in which an unexpected boarding state exists but requires no input from an associated caregiver for resolution, and a second status in which an unexpected boarding state exists and requires further input from an associated caregiver.

18. The method of claim 17, wherein the one or more hierarchical status parameters comprise at least a period of time in which an unexpected boarding state must be resolved before transitioning from the first status to the second status.

19. The method of claim 14, wherein each of the individuals are assigned to a respective one of the plurality of transport vehicles, for each day of a week and further for each of transport from the origin to the destination and transport from the destination to the origin, based on input data received via the first user interfaces.

20. The method of claim 14, comprising selectively generating route data specific to one or more of the expected group of individuals on the associated second user interface, and further to update the route data in substantially real time based on corresponding inputs from a respective caregiver.
